(19) United States
(12) Patent Application Publication
(10) Pub. No.: US 2021/0112652 A1
(43) Pub. Date: Apr. 15, 2021

(54) PLASMA TORCH

(71) Applicant: PLASMA TAEWOO CO., LTD., Seoul (KR)

(72) Inventor: Ji Sung HWANG, Seoul (KR)

(21) Appl. No.: 17/068,141

(22) Filed: Oct. 12, 2020

(30) Foreign Application Priority Data
Oct. 15, 2019 (KR) 10-2019-0128093

(51) Int. Cl. H05H 1/28

(52) U.S. Cl. CPC H05H 1/28

(57) ABSTRACT

Provided is a plasma torch in which a cathode conduit is disposed to be spaced apart from an outer circumferential surface of a cooling conduit, an insulator and an anode conduit are sequentially disposed around the cathode conduit in a closely abutting relation, an electrode element is engagingly coupled to a left end of the cathode conduit, and a nozzle is engagingly coupled to a left end of the anode conduit, and in which the cooling conduit includes one or more small peripheral radial air outlets formed on an outer circumferential surface of a left side end thereof so as to be opened at one sides of the air outlets, and a large central air outlet formed at the center of the left end thereof so that the left end of the cooling conduit is brought into close contact with an inner bottom of the electrode element.

### BACKGROUND OF THE INVENTION

### 1. Field of the Invention

The present invention relates to a plasma torch. More specifically, the present invention relates to a plasma torch in which a cathode conduit is disposed so as to be spaced apart from an outer circumferential surface of a cooling conduit, an insulator and an anode conduit are sequentially disposed around the cathode conduit in a closely abutting relation, an electrode element is engagingly coupled to a left side end of the cathode conduit, and a nozzle is engagingly coupled to a left side end of the anode conduit, and in which the cooling conduit includes a plurality of small peripheral radial air outlets formed on an outer circumferential surface of a left side end thereof in such a manner as to be opened at one sides of the air outlets, and a large central air outlet formed at the center of the left side end thereof so that the left side end of the cooling conduit is brought into close contact with an inner bottom surface of the electrode element, and thus in a state where the central air outlet is closed by the inner bottom surface and only the small peripheral radial air outlets are opened, when cooled air is supplied to the cooling conduit, it is ejected through only the small peripheral radial air outlets at high flow rate under a high pressure and simultaneously is heat-exchanged with air of the bottom surface of the electrode core holder overheated, and then discharged to the outside through the air passage, thereby significantly increasing the air discharge pressure at the peripheral radial air outlets and thus maximizing the cooling efficiency of the electrode element.

### 2. Description of Related Art

In general, a plasma cutting device includes a plasma torch, a dehumidified air supply device and a power supply device. The plasma torch emits ultra-high temperature plasma energy and is used to cut a thick iron plate, a nonferrous metal plate or the like.

In the meantime, as shown in FIG. 1, a conventional plasma torch according to the prior art is configured such that a cooling conduit 11 is inserted into a cylindrical cathode conduit 12 and then an electrode element 15 is engagingly coupled to a left side end of the cathode conduit 12, an insulator 33 is disposed on an outer circumferential surface of the cathode conduit 12, and an anode conduit 14 is disposed on an outer circumferential surface of the insulator 33 in such a manner that a nozzle 16 is engagingly coupled to a left side end of the anode conduit 14.

Herein, the electrode element has an interior air passage formed therein so as to fluidically communicate with an interior air passage of the cathode conduit, and the cathode conduit has a left branched hole formed at a left side thereof to allow a cooled air of the electrode element interior air passage to be fed to an arc tunnel and a right branched hole formed at a right side thereof. The right branched hole formed at the right side of the cathode conduit is configured such that a cooled air of the cathode conduit interior air passage passes through an insulator branched hole and an anode conduit branched hole sequentially, and then is ejected to the inside of a ceramic cover.

In addition, a female screw formed on an inner circumferential surface of the cathode conduit is engaged with a male screw formed on an outer circumferential surface of the electrode element, and the cooling conduit has a plurality of distribution grooves formed at a left front end thereof and the anode conduit has a cooling unit formed at an outer left side thereof so that the cooled air having passed through a communicating passage of the cathode conduit and the electrode element interior air passage sequentially is ejected through an ejection hole of the nozzle to cause the cooling unit to be cooled.

Further, a compressed air of 5 Kg/cm² supplied to the cooling conduit flows into the cathode conduit through a plurality of air distribution grooves formed on the inner surface of the electrode element mounted with an electrode core, and is dissociated while passing through the branched holes of the cathode conduit and then the arc tunnel defined between the electrode element and the nozzle disposed at the front end of the anode conduit supported by the insulator. Thereafter, the dissociated compressed air is ejected as a plasma flame onto a workpiece surface to be cut through the ejection hole of the nozzle, and the air is partially guided to a conduit line from the cathode conduit so as to be sprayed to the surroundings of the plasma flame while cooling the nozzle at the ejection hole between the nozzle and the cover.

However, the conventional plasma torch entails a problem in that the electrode element is required to be replaced with a new one frequently during the workpiece cutting process due to oxidation and deformation thereof, resulting in decreases of the working efficiency and the progress rate.

As such, the oxidation and deformation of the electrode element is attributed to a corrosion caused by the internal deterioration of the electrode element, particularly to the fact that the cooled air discharged to a central through-passage of a left side end of the cooling conduit does not cool sufficiently the interior of the electrode element.

### PRIOR ART LITERATURE

### Patent Documents

Patent document 1: Korean Utility Model Registration Publication No. 20-0173555

### SUMMARY OF THE INVENTION

The present invention has been made to solve the above-mentioned problems associated with the prior art, and it is an object of the present invention to provide a plasma torch in which a cathode conduit is disposed so as to be spaced apart from an outer circumferential surface of a cooling conduit, an insulator and an anode conduit are sequentially disposed around the cathode conduit in a closely abutting relation, an electrode element is engagingly coupled to a left side end of the cathode conduit, and a nozzle is engagingly coupled to a left side end of the anode conduit, and in which the cooling conduit includes a plurality of small peripheral radial air outlets formed on an outer circumferential surface of a left side end thereof in such a manner as to be opened at one sides of the air outlets, and a large central air outlet formed at the center of the left side end thereof so that the left side end of the cooling conduit is brought into close contact with an inner bottom surface of the electrode element, and thus in a state where the central air outlet is closed by the inner bottom surface and only the small peripheral radial air outlets are opened, when cooled air is supplied to the cooling conduit, it is ejected through only the small peripheral radial air outlets at high flow rate under a high pressure and simultaneously is heat-exchanged with air of the bottom surface of the electrode core holder overheated, and then discharged to the outside through the air passage, thereby significantly increasing the air discharge pressure at the peripheral radial air outlets and thus maximizing the cooling efficiency of the electrode element.

Another object of the present invention is to provide a plasma torch in which a left side end of a cooling conduit is brought into close contact with the bottom surface of an electrode core holder so that the cooling conduit serves as a heat-dissipating pipe in which heat is transferred from the bottom surface of the electrode core holder to the cooling conduit at one time, and simultaneously the cooled airs inside and outside the cooling conduit are discharged while being heat-exchanged, and thus the heat of the electrode element is dissipated and cooled through the cooling conduit, thereby maximizing the cooling efficiency of the electrode element.

To achieve the above objects, the present invention provides a plasma torch including: a cooling conduit; a cathode conduit disposed so as to be spaced apart from an outer circumferential surface of the cooling conduit; an insulator and an anode conduit sequentially disposed around the cathode conduit in a closely abutting relation; an electrode element engagingly coupled to a left side end of the cathode conduit; and a nozzle engagingly coupled to a left side end of the anode conduit, wherein the cooling conduit includes one or more peripheral radial air outlets formed on an outer circumferential surface of a left side end thereof in such a manner as to be opened at one sides of the air outlets, and a central air outlet formed at the center of the left side end thereof so that the left side end of the cooling conduit is brought into close contact with an inner bottom surface of the electrode element.

In the plasma torch of the present invention, the cooling conduit may include a small-diameter part and a large-diameter part linearly connected to a right side end of the small-diameter part in a central axial direction so as to be integrally formed with the small-diameter part, and each of the peripheral radial air outlets may be formed in a half-moon shape.

In the plasma torch of the present invention, the cathode conduit may include a space part formed at a right side of an inner circumferential surface thereof to allow a right side portion of the cooling conduit to be inserted thereinto, the space part including an insulator interposed between a right side end of the cooling conduit and a spring disposed at a right side end of the inner circumferential surface of the cathode conduit so that the cooling conduit is elastically supported by the spring.

In the plasma torch of the present invention, the cathode conduit may include a stepped part formed on an inner circumferential surface of a right side portion thereof so as to restrict the rightward movement of a flange formed at the large-diameter part of the cooling conduit.

In the plasma torch of the present invention, the cooling conduit may be made of a cupper (Cu) material.

### Effects of the Invention

As described above, the plasma torch according to this embodiment as constructed above has the effects in that a cathode conduit is disposed so as to be spaced apart from an outer circumferential surface conduit, an insulator and an anode conduit are sequentially disposed around the cathode conduit in a closely abutting relation, an electrode element is engagingly coupled to a left side end of the cathode conduit, and a nozzle is engagingly coupled to a left side end of the anode conduit, and in that the cooling conduit includes a plurality of small peripheral radial air outlets formed on an outer circumferential surface of a left side end thereof in such a manner as to be opened at one sides of the air outlets, and a large central air outlet formed at the center of the left side end thereof so that the left side end of the cooling conduit is brought into close contact with an inner bottom surface of the electrode element, and thus in a state where the central air outlet is closed by the inner bottom surface and only the small peripheral radial air outlets are opened, when cooled air is supplied to the cooling conduit, it is ejected through only the small peripheral radial air outlets at high flow rate under a high pressure and simultaneously is heat-exchanged with air of the bottom surface of the electrode core holder overheated, and then discharged to the outside through the air passage, thereby significantly increasing the air discharge pressure at the peripheral radial air outlets and thus maximizing the cooling efficiency of the electrode element.

In addition, the plasma torch according to the present invention has the effects in that a left side end of a cooling conduit is brought into close contact with the bottom surface of an electrode core holder so that the cooling conduit serves as a heat-dissipating pipe in which heat is transferred from the bottom surface of the electrode core holder to the cooling conduit, and simultaneously the cooled airs inside and outside the cooling conduit are discharged while being heat-exchanged, and resultantly the heat of the electrode element is dissipated and cooled through the cooling conduit, thereby maximizing the cooling efficiency of the electrode element.

### BRIEF DESCRIPTION OF THE DRAWINGS

The above and other objects, features and advantages of the present invention will be more apparent from the following detailed description of the preferred embodiments of the invention in conjunction with the accompanying drawings, in which:

FIG. 1 is a cross-sectional view showing an inner structure of a conventional plasma torch according to the prior art;

FIG. 2 is a cross-sectional view showing an inner structure and an air flow of a plasma torch according to a preferred embodiment of the present invention;

FIG. 3 is a cross-sectional view showing a state in which an electrode element of a plasma torch according to a preferred embodiment of the present invention has not been engagingly coupled to a cathode conduit thereof;

FIG. 4 is a cross-sectional view showing a state in which an electrode element of a plasma torch according to a preferred embodiment of the present invention has been engagingly coupled to a cathode conduit thereof;

FIG. 5 is a cross-sectional view showing a disassembled state of a cooling conduit, an insulator, a spring, and an end cap bolt of a plasma torch according to a preferred embodiment of the present invention; and

FIG. 6 is a cross-sectional view showing a disassembled state of an electrode element, a nozzle, and an insulation cap of a plasma torch according to a preferred embodiment of the present invention.

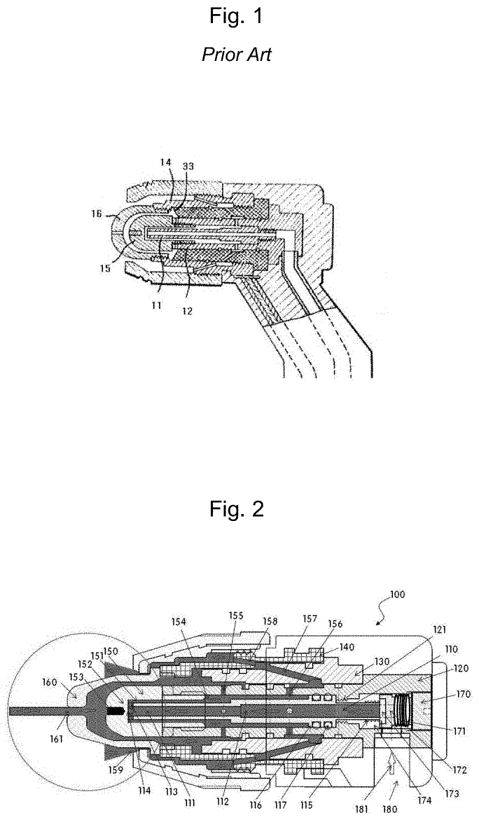

### EXPLANATION ON SYMBOLS

11: cooling conduit 12: cathode conduit
33: insulator 14: anode conduit
15: electrode element 16: nozzle
100: plasma torch 110: cooling conduit
111: small-diameter part 112: large-diameter part
113: peripheral radial air outlets
114: central air outlet
115: cooling conduit male screw 116: flange
117: O-ring 120: cathode conduit
121: cathode conduit female screw 130: insulator
140: anode conduit 150: electrode element
151: electrode element interior air passage
152: electrode core holder
153: electrode core 154: cathode conduit interior air passage
155: cathode conduit left vent hole
156: cathode conduit right vent hole
157: insulator vent hole
158: anode conduit vent hole
159: anode conduit cooled air ejection hole
160: nozzle
161: nozzle ejection hole 170: end cap bolt
171: spring 172: insulator
173: seating recess 174: space part
180: air inlet 181: air flow direction arrow

### DESCRIPTION OF THE PREFERRED EMBODIMENTS

Now, a plasma torch according to the preferred embodiments of the present invention will be described hereinafter in detail with reference to the accompanying drawings.

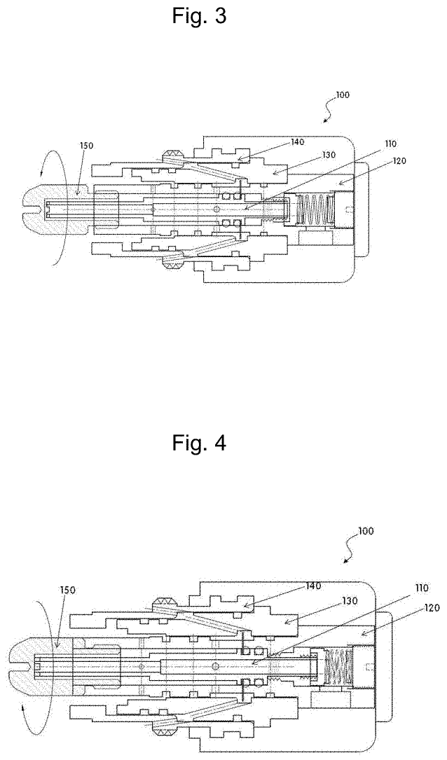

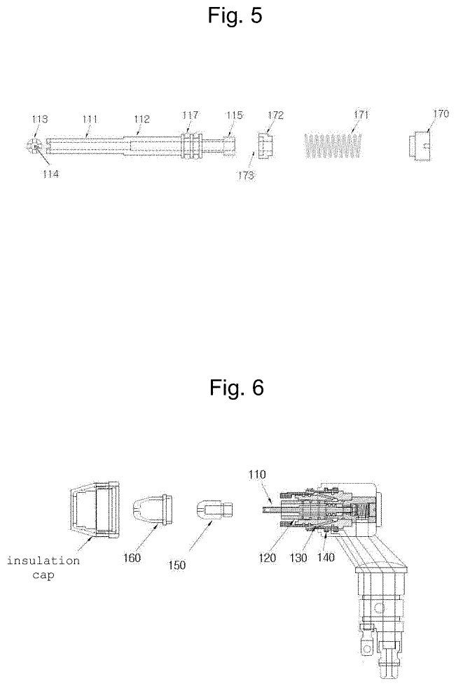

FIGS. 2 to 6 are views showing a plasma torch according to a preferred embodiment of the present invention.

The plasma torch of the present invention is configured such that a cathode conduit 120 is disposed so as to be spaced apart from an outer circumferential surface of a cylindrical cooling conduit 110, an insulator 130 and an anode conduit 140 are sequentially disposed around the cathode conduit in a closely abutting relation, an electrode element 150 is engagingly coupled to a left side end of the cathode conduit, and a nozzle 160 is engagingly coupled to a left side end of the anode conduit.

Herein, the electrode element 150 is formed in a generally conical shape, and includes an electrode core holder 152 formed at an axial central portion of a main body thereof so as to be opened at one end of the electrode core holder to allow an electrode core to be insertedly mounted therein so that a left side end of the cooling conduit is disposed in close proximity to an inner bottom surface of the electrode core holder 152.

In addition, the cooling conduit 110 includes a small-diameter part 111 and a large-diameter part 112 linearly connected to a right side end of the small-diameter part 111 in a central axial direction so as to be integrally formed with the small-diameter part 111, so that a half-moon shaped peripheral radial air outlet 113 formed in plural numbers on an outer circumferential surface of a left side end of the small-diameter part 111 in such a manner as to be opened at one side of the air outlet and a central air outlet 114 is formed at the center of the left side end of the small-diameter part 111.

Further, the cathode conduit includes a stepped part formed on an inner circumferential surface of a right side portion thereof so as to restrict the rightward movement of a flange 116 formed at the large-diameter part of the cooling conduit.

Herein, a female screw 121 is formed at the stepped part of the cathode conduit so as to correspond to a male screw 115 formed on the outer circumferential surface of a right side end of the large-diameter part of the cooling conduit. A hollow insulator 172 is interposed between the right side end of the large-diameter part and a spring 171 disposed at a right side end of the inner circumferential surface of the cathode conduit 120, and a seating recess 173 is formed at a left side end of the insulator 172 to allow the right side end of the large-diameter part to be insertedly seated therein.

In addition, the flange 116 formed with an insertion groove for an O-ring 117 is disposed on the outer circumferential surface of the right side of the large-diameter part in such a manner that the outer diameter of the flange is larger than the inner diameter of the cathode conduit female screw 121 so that the cathode conduit female screw restricts the rightward movement of the flange. The O-ring 117 inserted into the insertion groove of the flange is press-fit between the inner circumferential surface of the cathode conduit and the flange so that the cooled air in the cathode conduit can be prevented from being leaked to the right side of the flange.

Further, a space part 174 is formed at a right side of the cathode conduit female screw 121 in such a manner that the inner diameter thereof is larger than the outer diameter of a cooling conduit female screw so that the insulator 172 elastically supported by the spring can be moved in a horizontal direction in the space part. In addition, an end cap bolt 170 at the right side of the spring is engagingly coupled to a right side end of the cathode conduit so as to restrict the rightward movement of the spring. (In addition, the cooling conduit is made of a cupper (Cu) material.

A coupling and operation relationship of the plasma torch of the present invention will be described in detail with reference to FIGS. 2 to 6.

In other words, as shown in FIG. 2, in a state in which the end cap bolt 170, the spring 171 and the insulator 172 have been sequentially disposed at the right side end of the cathode conduit 120 in the plasma torch including the cooling conduit 110, the cathode conduit 120, the insulator 130, and the anode conduit 140, when the cooling conduit is rotated after directing the cooling conduit male screw 115 toward the left side end of the cathode conduit 120 and then inserting the cooling conduit into the cathode conduit, the cooling conduit male screw is passed through the cathode conduit female screw while rotating and is inserted into the space part of the cathode conduit.

Thereafter, when the left side end of the cooling conduit is allowed to be inserted into an inner hollow part of the electrode element and then the electrode element is engagingly coupled to the cathode conduit, the right side end of the cooling conduit is inserted into the seating recess of the insulator elastically supported by the spring and simultaneously is moved rightwardly to compress the spring. At this time, the cooling conduit is supported by an elastic force of the spring to cause the left side end of the cooling conduit to more closely abut against the inner bottom of the electrode core holder.

In addition, when the nozzle is engagingly coupled to the anode conduit, the plasma torch is placed in a usable state.

When the plasma torch and a matrix is electrically charged positively and negatively and the matrix is cut with high speed plasma flame (340 m/sec) and deep-seated pilot arc (deep-seated flame is plasma), a plasma jet ejects the gas dissociated by arc heat in the torch at high speed.

In this case, the cooled air (e.g., humidified compressed air of 5 kg/cm²) introduced into the plasma torch through an air inlet 180 along an air flow direction arrow 181 passes through the central air outlet and the peripheral radial air outlets simultaneously via the large-diameter part and the small-diameter part of the cooling conduit, and then is ejected to the outside through a cathode conduit interior air passage 154, a cathode conduit left vent hole 155 and a cathode conduit right vent hole 156, a nozzle ejection hole 161, an insulator vent hole 157, an anode conduit vent hole 158, and an anode conduit cooled air ejection hole 159 via an electrode element interior air passage 151.

In this case, as shown in FIG. 2, since the left side end of the cooling conduit is brought into close contact with the bottom surface of the electrode core holder 152, the air passage of the large central air outlet is blocked by the bottom surface of the electrode core holder and air is discharged only through the small peripheral radial air outlets, so that the air discharge passage is reduced to ‘the peripheral radial air outlets’ of the present invention from ‘the central air outlet+the peripheral radial air outlets’ of the conventional plasma torch. Thus, the discharged air pressure and the fluid flow rate at the small peripheral radial air outlets increase significantly as compared to those of the conventional plasma torch.

As described above, according to the plasma torch of this embodiment, a cathode conduit is disposed so as to be spaced apart from an outer circumferential surface conduit, an insulator and an anode conduit are sequentially disposed around the cathode conduit in a closely abutting relation, an electrode element is engagingly coupled to a left side end of the cathode conduit, and a nozzle is engagingly coupled to a left side end of the anode conduit. In addition, the cooling conduit includes a plurality of small peripheral radial air outlets formed on an outer circumferential surface of a left side end thereof in such a manner as to be opened at one sides of the air outlets, and a large central air outlet formed at the center of the left side end thereof so that the left side end of the cooling conduit is brought into close contact with an inner bottom surface of the electrode element, and thus in a state where the central air outlet is closed by the inner bottom surface and only the small peripheral radial air outlets are opened, when cooled air is supplied to the cooling conduit, it is ejected through only the small peripheral radial air outlets at high flow rate under a high pressure and simultaneously is heat-exchanged with air of the bottom surface of the electrode core holder overheated, and then discharged to the outside through the air passage, thereby significantly increasing the air discharge pressure at the peripheral radial air outlets and thus maximizing the cooling efficiency of the electrode element.

While the present invention has been described in connection with the exemplary embodiments illustrated in the drawings, they are merely illustrative and the invention is not limited to these embodiments. It will be appreciated by a person having an ordinary skill in the art that various equivalent modifications and variations of the embodiments can be made without departing from the spirit and scope of the present invention. Therefore, the true technical scope of the present invention should be defined by the technical spirit of the appended claims.

What is claimed is:

1. A plasma torch comprising:
a cooling conduit (110);
a cathode conduit (120) disposed so as to be spaced apart from an outer circumferential surface of the cooling conduit (110);
an insulator (130) and an anode conduit (140) sequentially disposed around the cathode conduit (120) in a closely abutting relation;
an electrode element (150) engagingly coupled to a left side end of the cathode conduit (120); and
a nozzle 160 engagingly coupled to a left side end of the anode conduit (130),
wherein the cooling conduit (110) comprises one or more peripheral radial air outlets (113) formed on an outer circumferential surface of a left side end thereof in such a manner as to be opened at one sides of the air outlets (113), and a central air outlet (114) formed at the center of the left side end thereof so that the left side end of the cooling conduit (110) is brought into close contact with an inner bottom surface of the electrode element (150).

2. The plasma torch according to claim 1, wherein the cooling conduit (110) comprises a small-diameter part (111) and a large-diameter part (112) linearly connected to a right side end of the small-diameter part (111) in a central axial direction so as to be integrally formed with the small-diameter part (111), and each of the peripheral radial air outlets (113) is formed in a half-moon shape.

3. The plasma torch according to claim 1, wherein the cathode conduit (120) comprises a space part (174) formed at a right side of an inner circumferential surface thereof to allow a right side portion of the cooling conduit (110) to be inserted thereinto, the space part (174) including an insulator (172) interposed between a right side end of the cooling conduit (110) and a spring (171) disposed at a right side end of the inner circumferential surface of the cathode conduit (120) so that the cooling conduit is elastically supported by the spring.

4. The plasma torch according to claim 2, wherein the cathode conduit (120) comprises a stepped part formed on an inner circumferential surface of a right side portion thereof so as to restrict the rightward movement of a flange (116) formed at the large-diameter part of the cooling conduit (110).

5. The plasma torch according to claim 1, wherein the cooling conduit (110) is made of a cooper (Cu) material.

6. The plasma torch according to claim 2, wherein the cooling conduit (110) is made of a cooper (Cu) material.

7. The plasma torch according to claim 3, wherein the cooling conduit (110) is made of a cooper (Cu) material.

8. The plasma torch according to claim 4, wherein the cooling conduit (110) is made of a cooper (Cu) material.
